(19) United States
(12) Patent Application Publication
(10) Pub. No.: US 2016/0227327 A1
(43) Pub. Date: Aug. 4, 2016

(54) Speaker Box

(71) Applicants: Bin Cai, Shenzhen (CN); Yunxia Xu, Shenzhen (CN)

(72) Inventors: Bin Cai, Shenzhen (CN); Yunxia Xu, Shenzhen (CN)

(73) Assignee: AAC Technologies Pte. Ltd., Singapore City (SG)

(21) Appl. No.: 14/984,438

(22) Filed: Dec. 30, 2015

(30) Foreign Application Priority Data
Feb. 2, 2015 (CN) 201520073252.7

(51) Int. Cl. H04R 9/02; H04R 7/12; H04R 1/32

(52) U.S. Cl. CPC H04R 9/025; H04R 1/323; H04R 7/127; H04R 2499/11

(57) ABSTRACT

A speaker box is disclosed in the present disclosure. The speaker box includes a housing having a receiving space and a sidewall provided with a sound output hole communicating with the receiving space for outputting sounds, and a sound generator received in the housing. The sound generator includes a magnetic circuit system provided with a near end close to the sound output hole and a far end away from the sound output hole, the magnetic field strength of the far end being greater than the magnetic field strength of the near end.

### FIELD OF THE INVENTION

The utility model relates to the field of speakers converting the electric signal into the sound wave, and especially to a speaker box with balanced vibration.

### DESCRIPTION OF RELATED ART

With the advent of the era of mobile Internet, the number of smart mobile devices continues to rise. Among a plurality of mobile devices, mobile phone is undoubtedly the most common and the most portable mobile terminal equipment. Currently, the mobile phone has especially lots of functions one of which is high-quality music function, whereas the speaker in the mobile phone is one of necessary conditions for realizing this high-quality music function. Most mobile phones in the current market generally use the micro electromagnetic speaker to realize the music playing function.

Generally, the speaker includes a basket forming a housing, a magnetic circuit system fixed in the basket, and a vibration system interacting with the magnetic circuit system and generating the vibration. The magnetic circuit system typically includes a magnetic bowl, a magnet fixed at the central position of the magnetic bowl, and a magnetic gap formed between the magnetic bowl and the magnetic steel; and the vibration system often includes a voice coil partially extended into the magnetic gap and a diaphragm connected with the voice coil.

When the electric signal containing audio signal is introduced into the voice coil, the voice coil will interact with the magnetic field of the magnetic circuit system to generate Ampere Force and stress the Ampere Force; and the voice coil realizes reciprocating vibration to drive the diaphragm to vibrate, thus generating the acoustic radiation.

As the development of intelligence degree of the mobile phone, there are more and more media content in the mobile phone, users also improve the requirements on media content and sound quality and hope the sound generator in the mobile phone can provide excellent low-frequency response, this requires the sound generator to have a large rear cavity and brings a structure where the cavity is used to enclose the sound generator body therein, and this structure is generally referred to as a speaker box.

The speaker box generally needs a sound output hole to output the sound radiated by the sound generator body to the outside, generally speaking, the position of the sound output hole in the speaker box is bias relative to the sound generator body, that is, the position of the sound output hole is deflected relative to the center of the sound generator body, which causes the vibration system of the sound generator body to be located at the near end close to the sound output hole and the far end away from the sound output hole; when the vibration system vibrates, the air close to the near end of the vibration system is easy to pass the sound output hole but the air at the far end is hard to pass the sound output hole, this situation can be simply understood as that the near end close to the sound output hole is easy to vibrate but the far end is relatively hard to vibrate, and this unbalances the vibration on the near end and the far end of the vibration system and further causes a series of problems such as the distortion.

Therefore, it is necessary to provide a new speaker box to solve the problems mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a speaker box in accordance with an exemplary embodiment of the present disclosure.

FIG. 2 is an exploded view of the speaker box in FIG. 1.

FIG. 3 is a broken view of the speaker box in FIG. 1.

FIG. 4 is a cross-sectional view of the speaker box in FIG. 1.

### DETAILED DESCRIPTION OF THE EXEMPLARY EMBODIMENT

The present invention will hereinafter be described in detail with reference to an exemplary embodiment. It should be understood the specific embodiments described hereby is only to explain this disclosure, not intended to limit this disclosure.

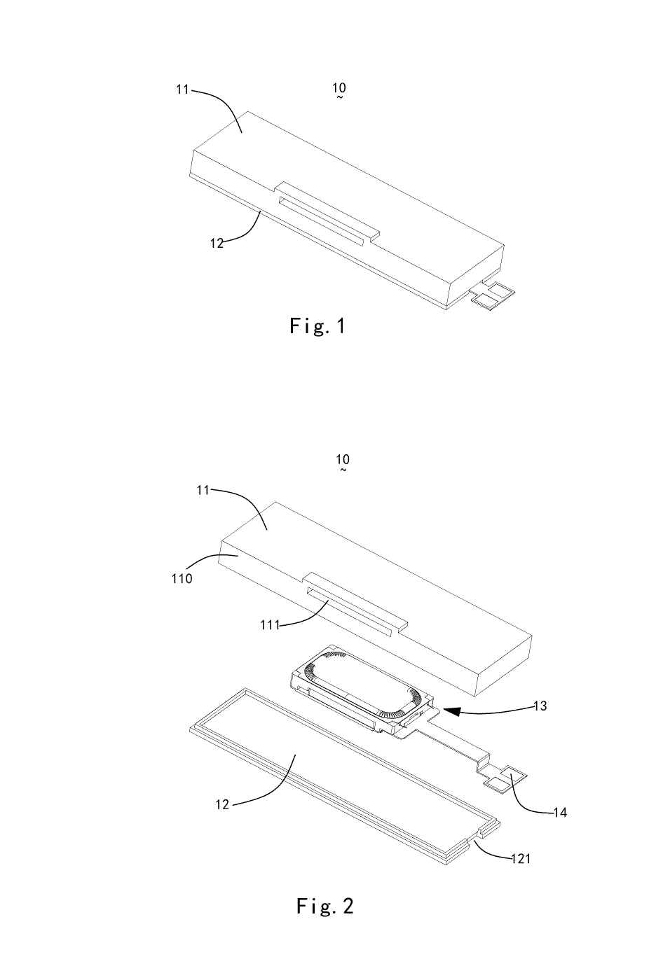

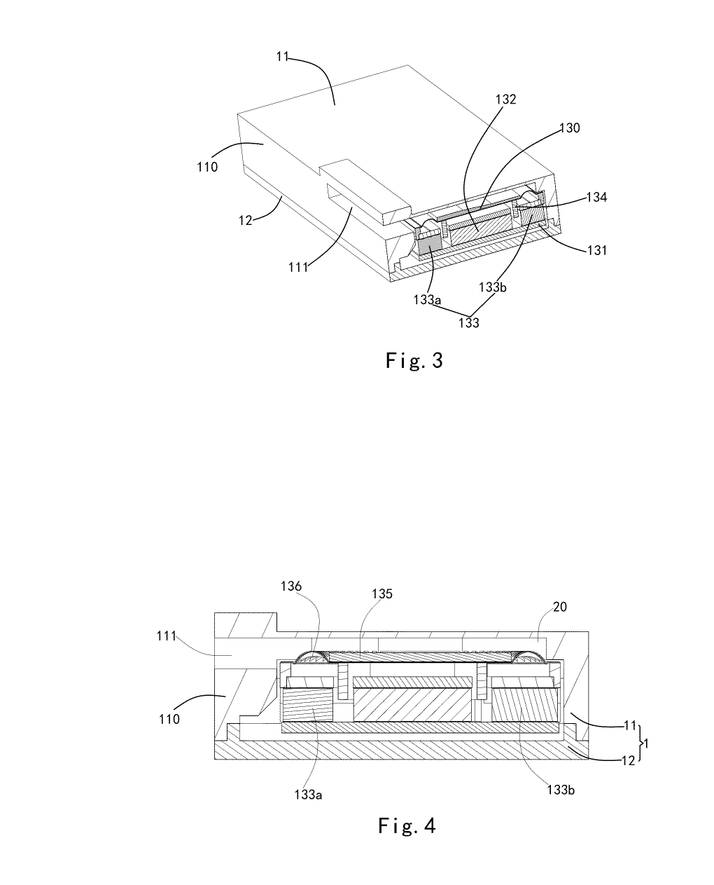

Referring to FIGS. 1-4, a speaker box 10 in accordance with an exemplary embodiment of the present disclosure, includes a shell 1 having a receiving space 20 and a sound generator 13 received in the shell 1. The shell 1 includes an upper shell 11, and a lower shell 12 engaging with the upper shell 11 for forming the receiving space 20. The upper shell 11 is provided with a sidewall 110. The sidewall 110 is provided with a sound output hole 111 communicating with the receiving space 20 and used for outputting the sound generated by the sound generator 13 out of the speaker box 10. The sound generator 13 is connected to an external circuit by a conductive element 14. In this embodiment, the conductive element 14 is a flexible circuit board. In order to conveniently connect the conductive element 14 to the outside, the lower shell 12 is provided with a gap 121, and the conductive element 14 is then connected to the outside through the gap 121.

The sound generator 13 further includes a magnetic circuit system and a vibration system interacting with the magnetic circuit system. The magnetic circuit system includes a lower plate 131, a primary magnet 132 fixed at a central position of the lower plate 131, a secondary magnet 133 fixed on the lower plate 131 and interlaced with the primary magnet 132, and a magnetic gap accordingly formed between the primary magnet 132 and the secondary magnet 133. The vibration system includes a voice coil 134 located in the magnetic gap and a diaphragm 130 for vibration and sound generation; and the diaphragm 130 further includes a dome part 135 located at the central position and a suspension 136 surrounding and supporting the dome part 135.

On the basis of the sound output hole 111, the magnetic circuit system is divided into a near end close to the sound output hole 111 and a far end away from the sound output hole 111. In this embodiment, the secondary magnet 133 includes a first secondary magnet 133a and a second secondary magnet 133b located on two ends of the primary magnet 132; the first secondary magnet 133a is located on the near end of the magnetic circuit system; and the second secondary magnet 133b is located on the far end of the magnetic circuit system.

In the vibration process of the diaphragm 130, the resistance to the part of the diaphragm 130 corresponding to the far end of the magnetic circuit system is greater than the resistance of the diaphragm 130 corresponding to the near end of the magnetic circuit system, which unbalances the vibration. The magnetic field strength of the far end of the magnetic circuit system is configured be greater than the magnetic field strength of the near end of the magnetic circuit system, therefore, the part of the diaphragm 130 corresponding to the far end of the magnetic circuit system is stressed with less driving power than the part of the diaphragm 130 corresponding to the near end of the magnetic circuit system and is easily to vibrate, thus reducing the sound resistance of the part of the diaphragm 130 corresponding to the far end, and balancing the vibration of the diaphragm, and reducing the distortion.

In order to realize the situation where the magnetic field strength of the far end is greater than the magnetic field strength of the near end, the volume of the second secondary magnet 133b can be configured be greater than the volume of the first secondary magnet 133a; the materials of the first secondary magnet 133a and the second secondary magnet 133b can be different, wherein the magnetic power of the material of the second secondary magnet 133b is greater than the magnetic power of the material of the first secondary magnet 133a; besides, the volume of the part of the primary magnet 132 close to the first secondary magnet 133s may be set to be less than the volume of the part of the primary magnet 132 close to the second secondary magnet 133b, of course, the magnetic power of the material of part of the primary magnet 132 close to the first secondary magnet 133a can be set to be less than the magnetic power of the material of the part of the primary magnet 132 close to the second secondary magnet 133b, that is, the primary magnet 132 can be made of two different materials, the magnetic power of the material of part of the primary magnet 132 close to the first secondary magnet 133a can be less than the magnetic power of the material of the part of the primary magnet 132 close to the second secondary magnet 133b.

Further, in this embodiment, the secondary magnet is divided into two split ones, actually, the secondary magnet can also be a single body, in this condition, the part of the secondary magnet located on one end of the primary magnet is the first secondary magnet, and the part of the secondary magnet located on the other end of the primary magnet is the second secondary magnet. Furthermore, the magnetic circuit system in this embodiment includes the primary magnet and the secondary magnet, actually, in the condition only having the primary magnet, the technical solution provided in the utility model is still applicable, that is, the circumference of the primary magnet can be provided with a magnetic conductor that is at least partially surrounding the primary magnet, and different effect of magnetic field strength can also be realized by setting the magnetic power of the parts of the primary magnet close to or away from the sound output hole (different materials or different volumes as described above).

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A speaker box, including:
a housing having a receiving space and a sidewall provided with a sound output hole communicating with the receiving space for outputting sounds;
a sound generator received in the housing, the sound generator including a magnetic circuit system provided with a near end close to the sound output hole and a far end away from the sound output hole, the magnetic field strength of the far end being greater than the magnetic field strength of the near end.

2. The speaker box as described in claim 1, wherein the magnetic circuit system includes a primary magnet, a first secondary magnet and a second secondary magnet located on two ends of the primary magnet; the first secondary magnet is located on the near end of the magnetic circuit system; and the second secondary magnet is located on the far end of the magnetic circuit system.

3. The speaker box as described in claim 2, wherein a volume of the first secondary magnet is less than a volume of the second secondary magnet.

4. The speaker box as described in claim 2, wherein the materials of the first secondary magnet is different from that of the second secondary magnet, the magnetic power of the material of the first secondary magnet is less than that of the second secondary magnet.
